(19) United States
(12) Patent Application Publication
(10) Pub. No.: US 2008/0257129 A1
(43) Pub. Date: Oct. 23, 2008

(54) MITCHEL'S TONE RING MATE

(76) Inventor: Mitchel Devern Meadors, Leawittsburg, OH (US)

Correspondence Address: MITCHEL MEADORS, 5303 BURNETT RD, LEAVITTSBURG, OH, 44430, US

(21) Appl. No.: 11/678,682

(22) Filed: Apr. 19, 2007

(51) Int. Cl. G10D 1/10

(52) U.S. Cl. 84/270

(57) ABSTRACT

“Mitchel's Tone Ring Mate” is completely new to the banjo world. The “Mitchel's Tone Ring Mate” is a smaller tone ring in itself, sitting on top of the original raised head tone ring at 25 thousands higher and at opposite angles, thus converting the original raised head tone ring to a flat head tone ring. Being completely different than any other invention. This doing, by design, composition and development, unknown in manufacturing there into.

### BACKGROUND

1. Field of Invention

This invention relates to the stringed musical instrument properly known as the banjo.

2. Description of Prior Art

The major components of a banjo rim assembly (circular part of banjo) are 1. head (skin or plastic) 2. tone ring (metal) 3. shell (usually wood): “Mitchel's Tone Ring Mate” (FIG. 1) installed on top and sitting in the raised head ring converting it to a flat head 4. sub parts to make previously mentioned parts into a single taut assembly.

Banjos Typically are of Two Types:
1. Raised head—having a tone ring that reduces the main vibrating area of the head to the approximate inside diameter measurement of the shell.
2. Flat head—having a tone ring that maintains the vibrating area of the head to the approximate outside diameter measurement of the shell.

### DESCRIPTION OF DRAWINGS

FIG. 1 is a full view of “Mitchel's Tone Ring Mate”

FIG. 2 is a cross-sectional exploded view of “Mitchel's Tone Ring Mate”

FIG. 3 is a view of the banjo components with “Mitchel's Tone Ring Mate” at the very top of the assembly.

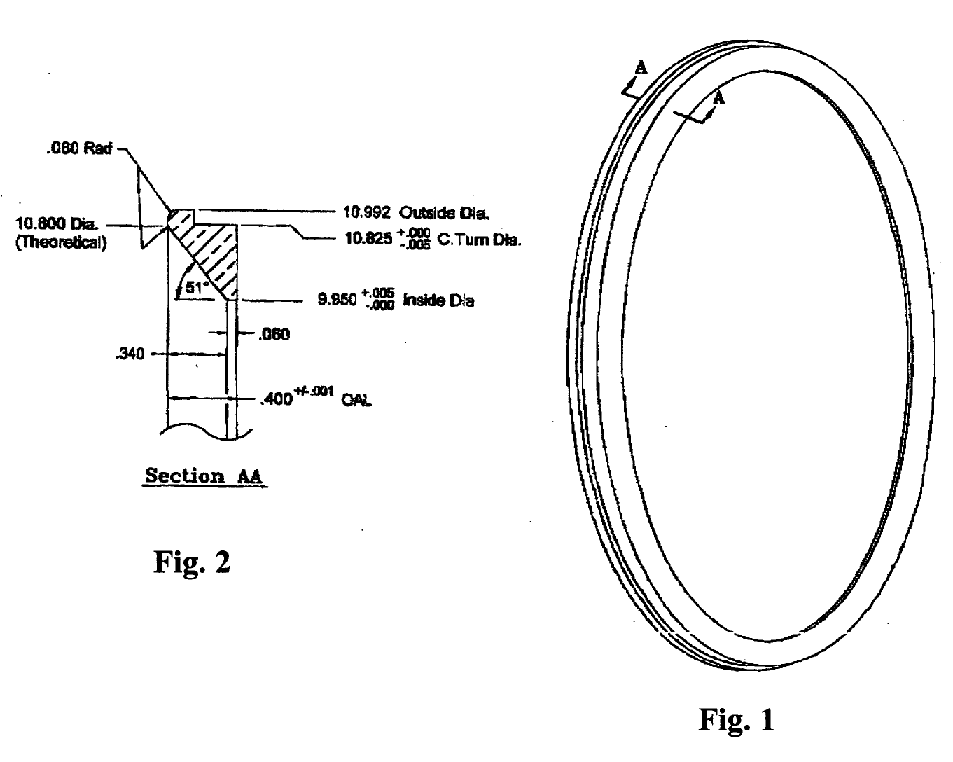

### DESCRIPTION OF THE PREFERRED EMBODIMENT

Installing “Mitchel's Tone Ring Mate” on the (original) raised head ring converts the (original) raised head ring to a flat head.

Previous conversions either eliminated the original ring or didn't sit inside and firmly on the flat inside surface of the original raised head ring; thus utilizing the pre-war material of the (original) raised head ring.

In relationship to the (original) raised head tone ring (as seen in FIG. (2)), “Mitchel's Tone Ring Mate” sits in the open cavity of the (original) raised head tone ring. The bottom's diameter, measuring at 10.825, rests on the inside bottom of (original) raised head tone ring setting against the inside of the (original) raised head tone ring with a diameter of 9.950. The outside diameter being 10.992 and setting on the outside skirt of (original) raised head tone ring, running perpendicular to the (original) raised head tone ring with a radius of 0.060 and a theoretical diameter of 10.800.

In reference to the 51° angle of the “Mitchel's Tone Ring Mate”, it starts at the 10.8 and goes to the 9.950 then back to the 0.340, has a height of 0.025 above the (original) raised head tone ring, thus forming a flat head tone ring conversion utilizing the (original) raised head tone ring with “Mitchel's Tone Ring Mate”.

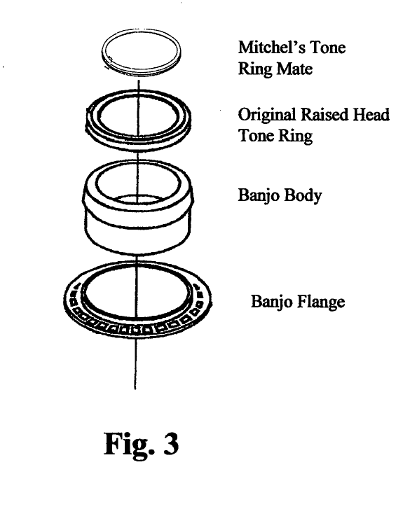

With “Mitchel's Tone Ring Mate”, as shown in drawing (FIG. 3) the owner simply removes the head, puts “Mitchel's Tone Ring Mate” inside raised head cavity and on top of (original) tone ring and reinstalls the head, converting this assembly to a pre-war sounding flat head by utilizing the (original) raised head ring material with “Mitchel's Tone Ring Mate”. No other conversion sits down in the raised head cavity and has a design that utilizes the raised head ring, then converting it to a flat head with the unique and new design of “Mitchel's Tone Ring Mate”.

I claim:

1. What I am claiming is “Mitchel's Tone Ring Mate”, for a banjo comprising an annular body means on said body for supporting said tone ring and the “Mitchel's Tone Ring Mate” on banjo shell.
The “Mitchel's Tone Ring Mate” in claim one wherein first means as resting on original raised head tone ring and extending the opposite direction from original raised head first direction and having a diameter slightly more than said original raised head ring and slightly higher than original ring and said tone ring. The said “Mitchel's Tone Ring Mate” in forming an opposite angle of said original tone ring and twenty-five thousands higher, but sitting on original raised head ring and inside said cavity of original tone ring; thus becoming part of the raised head ring and converting it to a flat head ring.
The “Mitchel's Tone Ring Mate” in claim two wherein said “Mitchel's Tone Ring Mate” is an integral structure made by casting and or machining processes.
